(19) United States
(12) Patent Application Publication
(10) Pub. No.: US 2026/0287415 A1
(43) Pub. Date: Sep. 24, 2026

(54) WEIGHING DEVICE

(71) Applicant: Reestar International Limited, Hong Kong (CN)

(72) Inventors: Xilu Qiao, Hong Kong (CN); Ruimin Li, Hong Kong (CN); Wesley King Juen Tong, Hong Kong (CN)

(21) Appl. No.: 19/206,022

(22) Filed: May 12, 2025

(30) Foreign Application Priority Data
Mar. 19, 2025 (CN) 202520489464.7

(51) Int. Cl. G01G 21/22; G01G 7/00

(52) U.S. Cl. CPC G01G 21/22; G01G 7/00

(57) ABSTRACT

A weighing device includes: a body shell, including a bearing surface configured to carry a to-be-weighed object; and at least one weighing sensor assembly, configured to weigh the to-be-weighed object carried on the bearing surface. At least a part of the bearing surface serves as a mirror surface.

### CROSS-REFERENCE TO RELATED APPLICATIONS

The present application claims the priority of the Chinese patent application No. 202520489464.7, filed on Mar. 19, 2025, and contents of which are incorporated herein by its entireties.

### FIELD

The present disclosure relates to the field of daily necessities, and particularly to a weighing device.

### BACKGROUND

A weighing device is commonly used for measuring a body weight a user. The weighing device is an intelligent weight measuring device that digitally displays the body weight of the user. The weighing device may be able to only measure the body weight and is used infrequently and is applicable to a limited application scenarios.

### SUMMARY

A weighing device includes: a body shell, including a bearing surface configured carry a to-be-weighed object; and at least one weighing sensor assembly, configured to weigh the to-be-weighed object carried on the bearing surface. At least a part of the bearing surface serves as a mirror surface.

### BRIEF DESCRIPTION OF THE DRAWINGS

To provide a clearer illustration of the technical solutions in the embodiments of the present disclosure or in the related art, a brief introduction will be given to the drawings used in the description of the embodiments or the related art.

FIG. 1 is a perspective schematic view of a weighing device according to an embodiment of the present disclosure.

FIG. 2 is an exploded view of the weighing device shown in FIG. 1.

FIG. 3 is a further exploded view of the weighing device shown in FIG. 1.

FIG. 4 is an exploded view of the weighing device shown in FIG. 1, being viewed from another viewing angle.

FIG. 5 is a cross-sectional view of the weighing device shown in FIG. 1, taken along a line A-A.

FIG. 6 is an enlarged view of a portion B in FIG. 5.

FIG. 7 is a perspective schematic view of the weighing device shown in FIG. 1 being covered by a bearing surface protective cover.

FIG. 8 is a structural schematic view of the weighing device shown in FIG. 1, where a bracket is taken out.

FIG. 9 is a schematic view of the weighing device shown in FIG. 1 in an in-use state.

FIG. 10 is a structural schematic view of the weighing device shown in FIG. 1, where a display module is extended out from a body shell.

FIG. 11 is an exploded view of a portion of the weighing device shown in FIG. 1, being viewed from another viewing angle.

FIG. 12 is an enlarged view of a portion F in FIG. 11.

FIG. 13 is a structural schematic view of the weighing device shown in FIG. 10, being viewed from another viewing angle.

FIG. 14 is a structural schematic view of the display module shown in FIG. 9 being extended out of the body shell.

FIG. 15 is an enlarged view of a portion E in FIG. 14.

FIG. 16 is an enlarged view of a portion D in FIG. 14.

FIG. 17 is a structural schematic view of the weighing device shown in FIG. 1, where the display module is received inside the body shell.

FIG. 18 is an enlarged view of a portion C in FIG. 17.

FIG. 19 is a perspective schematic view of a portion of the weighing device shown in FIG. 1, where one support is arranged.

FIG. 20 is a cross-sectional view of the weighing device shown in FIG. 19, taken along a line G-G.

FIG. 21 is a perspective schematic view of the weighing device according to another embodiment of the present disclosure.

### DETAILED DESCRIPTION

In order to make objectives, features and advantages of the present disclosure more obvious and understandable, the specific embodiments of the present disclosure will be described in detail below by referring to the accompanying drawings.

In order to enable any ordinary skilled person in the art to better understand technical solutions of the present disclosure, the technical solutions in the embodiments of the present disclosure will be clearly and completely described below by referring to the accompanying drawings in the embodiments of the present disclosure.

It should be noted that terms “first”, “second”, and so on in the specification and the claims of the present disclosure and the accompanying drawings are used to distinguish between similar objects, and do not describe a particular order or sequence. It should be understood that the terms may be interchangeable where appropriate, such that the embodiments of the present disclosure described herein may be implemented in an order other than those illustrated or described herein. In addition, terms “include”, “have” and any variations thereof are intended to cover non-exclusive inclusion.

It should also be noted that the division of multiple embodiments in the present disclosure is solely for convenience of description and shall not constitute a particular limitation, and features in various embodiments may be combined and referred with each other without contradiction.

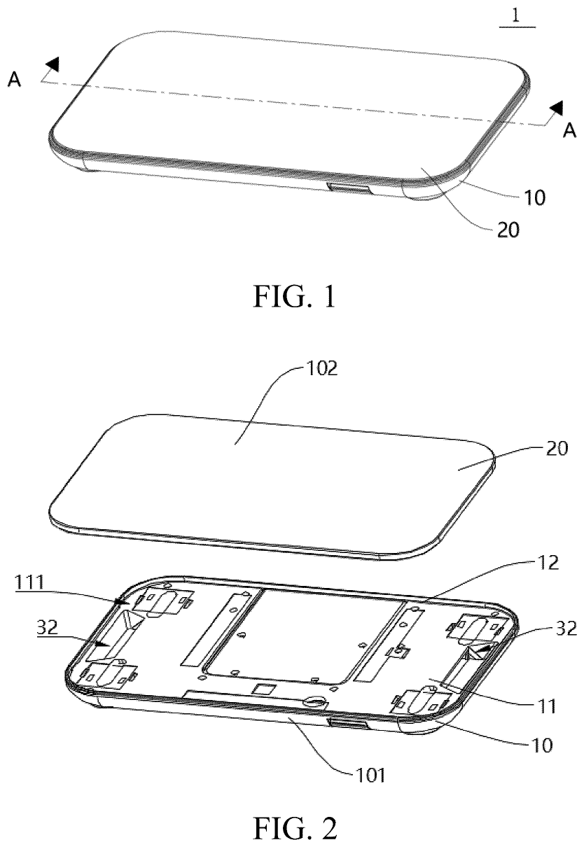

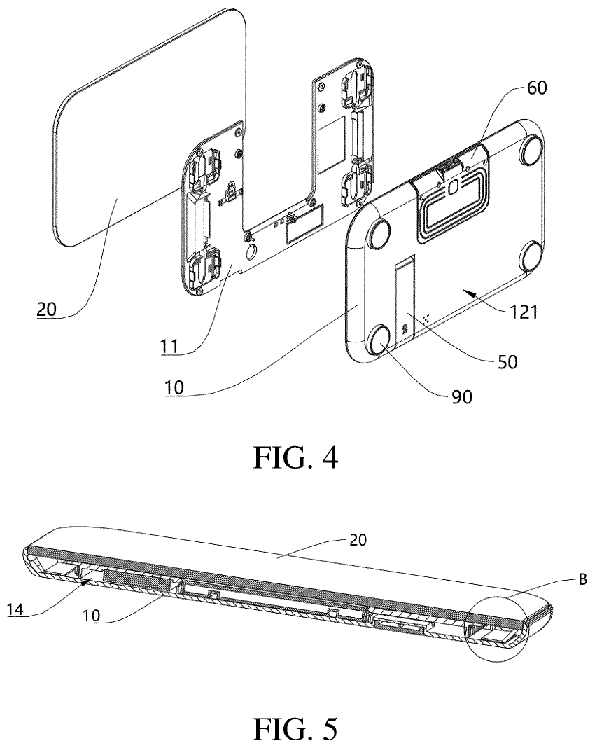

As shown in FIGS. 1, 2, 3 and 4, the present disclosure provides a weighing device 1, including a body shell 10. In some embodiments, the body shell 10 is configured to be substantially flat and rectangular, such that the weighing device 1 may be portable by a user. The body shell 10 may include a base 101 and a top cover 102. An end surface 111 at a top of the base 101 is open, and the top cover 102 is arranged on the open end surface 111. A side of the top cover 102 away from the base 101 serves as a bearing surface 20 for carrying a to-be-weighed object. At least a part of the bearing surface 20 is configured as a mirror surface, such that the user may use the weighing device 1 as a mirror when weighing is not performed. The top cover 102 and the base 101 cooperatively form a mounting space 12, and a weighing sensor assembly 83 may be received in the mounting space 12 or mounted on a bottom wall 121 of the base 101. When the user uses the weighing device for weighing, the to-be-weighed object is placed on a side of the weighing device having the bearing surface 20, or feet of the user may step on the side having the bearing surface 20, and weighing is performed by the weighing sensor assembly 83. In summary, the weighing device 1 in the present disclosure has a weighing function and can be used as the mirror, such that applicability of the weighing device 1 is improved.

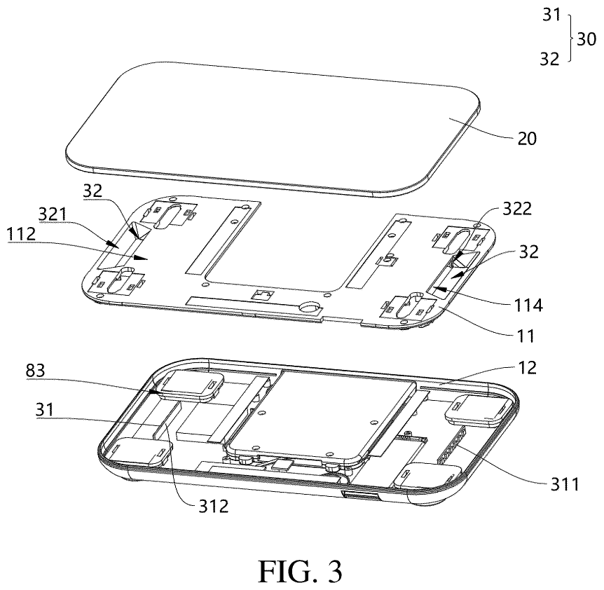

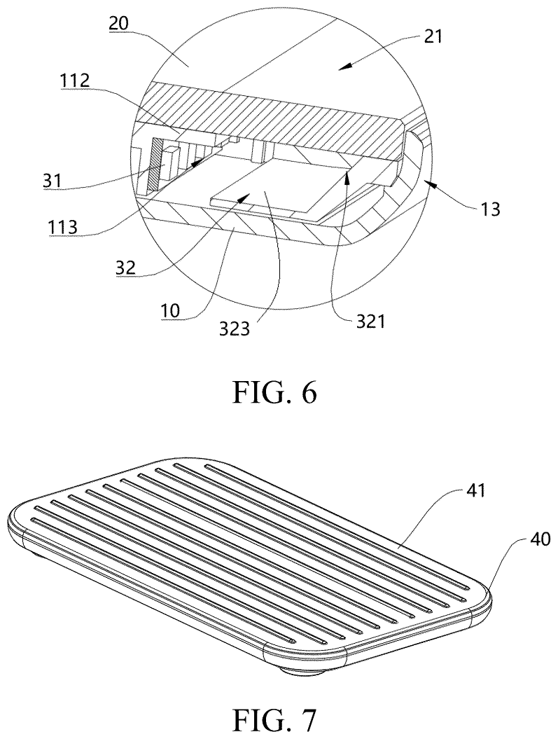

In an embodiment, as shown in FIGS. 3, 4, 5, and 6, the weighing device 1 is further arranged with a light replenishing assembly 30. A substrate 11 is further arranged inside the body shell 10. The substrate 11 is disposed between the bearing surface 20 and the bottom wall 121 of the base 101. The light replenishing assembly 30 is formed on the substrate 11. In some embodiments, two replenishing assemblies 30 are arranged and are respectively disposed at a left end and a right end of the bearing surface 20. A light-transmitting region 21 is arranged at each of the left end and the right end of the bearing surface 20. The light-transmitting region 21 allows light to pass through. The bearing surface 20 may be a polished surface obtained by polishing a metal surface, or may be obtained by coating a reflective layer on a rear side of glass or transparent plastic. When the polished surface is used as the bearing surface 20, the entire bearing surface 20 is used as the mirror. When the reflective layer is applied to achieve a mirror effect, a part of the bearing surface 20 is used as the mirror, and another part of the bearing surface 20 is used as the light-transmitting region 21. Alternatively, when the reflective layer is applied to achieve the mirror effect, the entire bearing surface 20 is used as the mirror, and a part of the bearing surface 20 may further be used as the light-transmitting region 21 at the same time. Alternatively, when the reflective layer is applied to achieve the mirror effect, the entire bearing surface 20 is used as both the mirror and the light-transmitting region 21 at the same time. The light replenishing assembly 30 has a light source 31, the light source 31 may be a LED lamp or any other type of light source. Light of the light source 31 may pass through the light-transmitting region 21. When the user is looking in the mirror, light transmitted from the left end and the right end of the bearing surface 20 illuminate a region around the bearing surface 20 for light replenish, such that an image in the bearing surface 20 can be clearly viewed in an ambient-light poor case. In some embodiments, one or more light replenishing assemblies 30 may be arranged to achieve the above technical effects.

In an embodiment, as shown in FIGS. 3, 4, 5, and 6, the light replenishing assembly 30 further includes a light guiding structure 32 and a light shielding portion 112. The light guiding structure 32 and the light shielding 112 are integrally formed with the substrate 11 to form a one-piece structure. The light shielding portion 112 defines a receiving cavity 113. A side of the light shielding portion 112 has an opening, serving as a light output side 114. The light output side 114 is communicated with the receiving cavity 113. The light source 31 is received in the inner receiving 113 and is disposed facing toward the light output side 114. The light guiding structure 32 includes a plane 323 arranged transversely and/or an inclined surface 321 facing the bearing surface 20. The plane 323 and/or the inclined surface 321 are disposed near the light output side 114. When the light guiding structure 32 is configured as only the plane 323, the light source 31 may be disposed to be inclined and facing the plane 323. In this case, light emitted from the light source 31 forms an angle with the plane 323. A smooth reflective layer is provided on the plane 323, such that emitted light may be reflected by the plane 323 toward the light-transmitting region 21 of the bearing surface 20. When the light guiding structure 32 is configured as only the inclined surface 321, an inclined light-guiding corner 322 is disposed on each of two sides of the inclined surface 321. The inclined light-guiding corner 322 and the inclined surface 321 may be provided with the smooth reflective layer. Since the inclined surface 321 is inclinedly disposed, the emitted light from the light source 31 may be laterally diffused, and the inclined surface 321 and the light-guiding corner 322 may reflect the light emitted from the light source 31 toward the light-transmitting region 21 of the bearing surface 20. In some embodiments, the light guiding structure 32 may be configured as the plane 323 and the inclined surface 321 connected to the plane 323, such that the plane 323 may reflect a part of the emitted light toward the light-transmitting region 21, and the inclined surface 321 may reflect the remaining part of the emitted light toward the light-transmitting region 21. The light replenishing assembly 30 further has the light shielding portion 112. The light shielding portion 112 includes a vertical plate. The light source 31 is disposed on the vertical plate. The light shielding portion 112 further includes a horizontal plate that covers a top side of the light source 31. The vertical plate and the horizontal plate cooperatively enables the light source 31 to emit light towards only the light guiding structure 32. The light shielding portion 112 prevents the light from being emitted directly from the light source 31, while the light guiding structure 32 directs the light toward the light-transmitting region 21 of the bearing surface 20. The light guiding structure 32 and the light shielding portion 112 are configured to reduce loss of light, improving a light replenishing effect, and ensuring the light to be uniformly distributed across the light-transmitting region 21 of the bearing surface 20, such that an even light replenishing effect is achieved. To be noted that the light guiding structure 32 and the light shielding portion 112 may be configured as an integral and one-piece structure or configured as separate structures. In an embodiment, as shown in FIG. 3, the light guiding structure 31, the light shielding portion 112, and the substrate 11 are integrally formed as a one-piece structure. In other embodiments, the light guiding structure 31, the light shielding portion 112, and the substrate 11 may be configured in three separate structures. The present disclosure does not limit the configuration thereof.

In an embodiment, as shown in FIGS. 3, 4, 5, and 6, the light output side 114 is configured as a strip-shaped opening. A light plate 312 is configured to be strip-shaped and is arranged along the light output side 114. A plurality of light beads 311 are arranged on the light plate 312. In some embodiments, the plurality of light beads 311 are capable of switching between cool light and warm light, such that light in various environments can be simulated, enabling the user to adapt to various make-up and environmental needs and reducing color differences.

In an embodiment, as shown in FIG. 7, the weighing device 1 is further provided with a bearing surface protective cover 40. When the user needs to use the weighing device for weighing, the bearing surface protective cover 40 may cover the bearing surface 20, and the object may be placed on the bearing surface protective cover 40 or the user may step on the bearing surface protective cover 40 for weighing. In some embodiments, the bearing surface protective cover 40 may be made of silicone or rubber to prevent scratching or cracking the bearing surface 20. The bearing surface protective cover 40 can cover the entire bearing surface 20. For example, the weighing device 1 may have the bearing surface 20 and another side opposite to the bearing surface 20. The bearing surface protective cover 40 may encase at least part of the weighing device 1, where the bearing surface 20 may be fully covered by the bearing surface protective cover 40, and an edge of the bearing surface protective cover 40 extends to reach the another side of the weighing device 1 opposite to the bearing surface 20. Alternatively, the bearing surface 20 may be fully covered by the bearing surface protective cover 40 while the edge of the bearing surface protective cover 40 may coincide with an edge of the bearing surface 20. Removable connection between the bearing surface protective cover 40 and the bearing surface 20 allows the user to conveniently remove the bearing surface protective cover 40 when weighing is not performed. The bearing surface protective cover 40 may be arranged with a plurality of anti-slip grooves 41, preventing the object or the user from slipping aside.

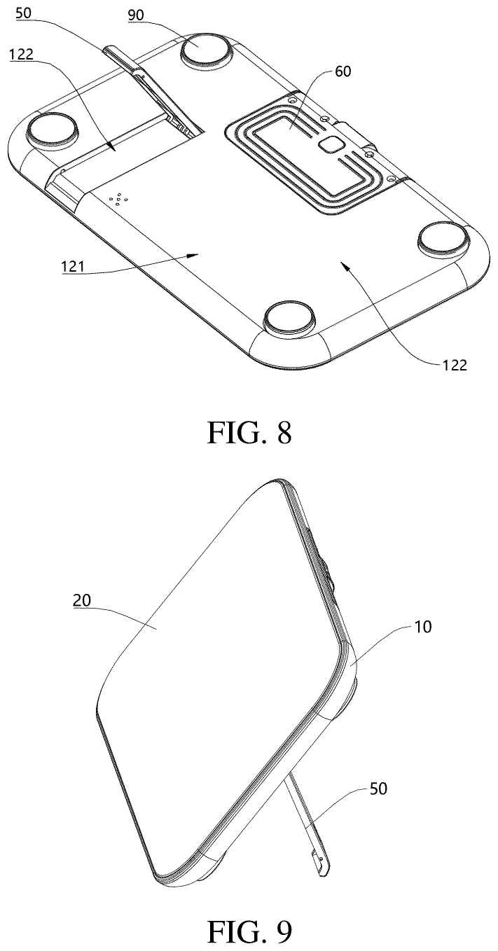

In an embodiment, as shown in FIGS. 8 and 9, the weighing device 1 is further disposed with a bracket 50, a side 122 of the body shell 10 away from the bearing surface 20 defines a storage slot 122. A rotation shaft is disposed at an end of the bracket 50. The bracket 50 is rotatably mounted in the storage slot 122 via the rotation shaft. A length of the storage slot 122 is greater than a length of the bracket 50. In a first state, the bracket 50 is fully expanded, and an angle is defined between the body shell 10 and the bracket 50, so as to support the body shell 10. In a second state, the bracket 50 is received, such that the weighing device 1 can be stored and carried easily. The bracket 50 may be rotated to adjust the angle between the bracket 50 and the body shell 10, allowing the bearing surface 20 to be fixed at various positions and angles. In this way, the user may freely adjust an angle of the mirror to obtain an optimal viewing angle and light effect.

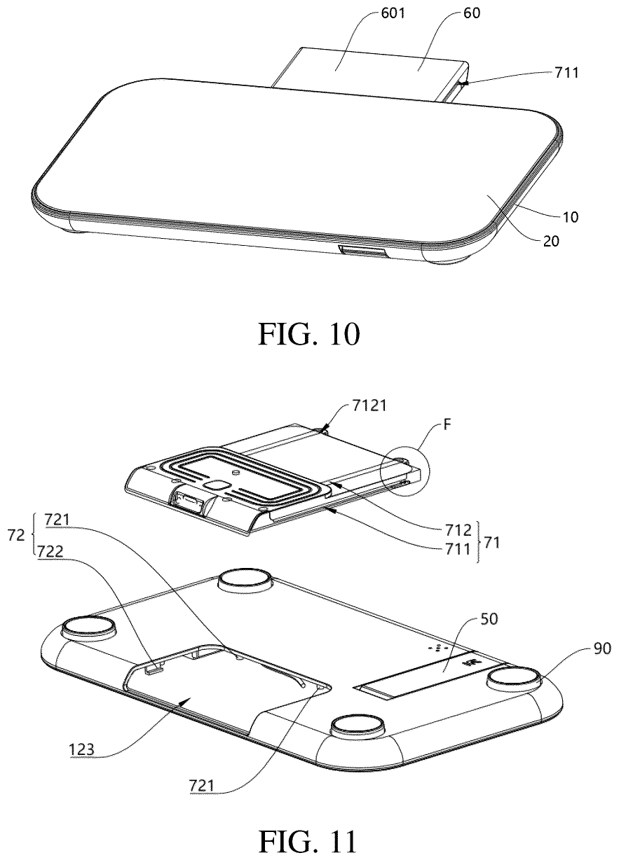

In an embodiment, as shown in FIG. 10, the weighing device 1 further includes a display module 60. The display module 60 is extendable and retractable. Extendable and retractable connection between the display module 60 and the body shell 10 allows the display module 60 to retract into or extend out from the body shell 10. In some embodiments, the extendable and retractable connection between the display module 60 and the body shell 10 may be achieved via a slide rail and a slide slot. The display module 60 being extendable and retractable allows the bearing surface 20 to be uninterrupted and to have a sufficiently large surface area, such that the bearing surface 20 may be used as the mirror conveniently. When t he display module 60 is extended outward, a numerical value of the weighing, a body fat rate, or other health data can be displayed by a display 601. In this way, an overall structure of the weighing device 1 is more compact, and an occupation space is reduced. To be noted that when the weighing device 1 is used as the mirror, the display module 60 may also be extended out from the body shell 10. Further, the weighing device 1 may further include a voice module. The display module 60 may be configured to display images, play videos, and so on. The voice module is configured to play audio. In this way, the user may view images, videos, or other content while using the weighing device 1 as the mirror, thus the user experience is improved. When the weighing device 1 is stored, the display module 60 may be retracted into the body shell 10, such that the space occupied by the weighing device 1 is reduced, and the weighing device 1 can be stored and placed by the user easily.

In another embodiment, as shown in FIG. 21, the display module 60 and the body shell 10 are folded with respect to each other. When the display module 60 is folded, the display 601 is completely attached to a surface of the body shell 10, and in some embodiments, the display 601 may be completely attached to the bearing surface 20. An area of the display 601 is smaller than an area of the bearing surface 20, such that the remaining area of the bearing surface 20 that is not attached to the display 601 still functions as the mirror. The folding functionality between the display module 60 and the body shell 10 may be achieved via a hinge mechanism. After the display module 60 is unfolded and extended out from the body shell 10, an angle is formed between the display 601 and the body shell 10. In order to facilitate the user to view weighing results and other relevant information, the angle may be 180 degrees or close to 180 degrees. In this way, while weighing and displaying functions are achieved, the weighing device 1 can still be used as the mirror.

It is noted that when the weighing device 1 is used as the mirror, the display module 60 may also be in the extended state. In this case, the display module 60 does not obstruct the bearing surface 20, such that the bearing surface 20 provides a larger area to serve as the mirror. Further, the weighing device 1 further includes the voice module. The display module 60 may be configured to display images, play videos, and so on, and the voice module is configured to play audio. In this way, when the user uses the weighing device 1 as the mirror, the user may at the same time view images, videos, and other content, such that the user experience is improved. When the weighing device 1 is stored, the display module 60 may be folded relative to the body shell, such that the space occupied by the weighing device 1 is reduced, and the weighing device 1 can be stored and placed by the user easily.

In an embodiment, as shown in FIG. 10, the display module 60 is extendable and retraction in a direction parallel to the bearing surface 20. When the display module 60 is extended or retracted, it is ensured that the display module 60 does not interfere with the bearing surface 20 or occupies any additional space. The display 601 is disposed facing toward the bearing surface 20, such that the user may naturally view the weighing results during weighing, improving the convenience and comfort of reading.

In an embodiment, as shown in FIG. 11, a receiving slot 123 is defined in the side 122 of the body shell 10 away from the bearing surface 20. An edge of the body shell 10 has an opening communicated to the receiving slot 123, such that the display module 60 may slide beyond the edge of the body shell 10 to display the weighing results. Optionally, the display module 60 is provided with a guide slot structure 71, and the body shell 10 is provided with a guide member structure 72; alternatively, the display module 60 is provided with the guide member structure 72, and the body shell 10 is provided with the guide slot structure 71. The guide slot structure 71 and the guide member structure 72 are slidably connected to each other, so as to guide the display module 60 to slide in the receiving slot 123, ensuring a sliding direction and stability of the display module 60 during sliding.

In an embodiment, as shown in FIGS. 11, 12 and 13, a back plate 604 is arranged at side away from the display 60. The back plate 604 is configured to fix the display 601 and other electronic components and to cooperate with the receiving slot 123 to enable sliding between the display module 60 and the body shell 10. In some embodiments, two first guiding slots 712 are defined and are arranged side by side on the back plate 604 along an extension-retraction direction of the display module 60. Two limiting posts 721 are provided and are respectively inserted into the two first guiding slots 712. Each limiting post 721 is a columnar structure fixed to the body shell 10 to be mated with the corresponding first guiding slot 712 and to guide the display module 60 to slide. It is to be understood that one or more first guiding slots 712 and one or more first limiting posts 721 may be provided. Mating between the limiting posts 721 and the first guiding slots 712 ensures that the display module 60 can be accurately positioned when sliding to reach a particular position, preventing misalignment or damage caused by improper sliding.

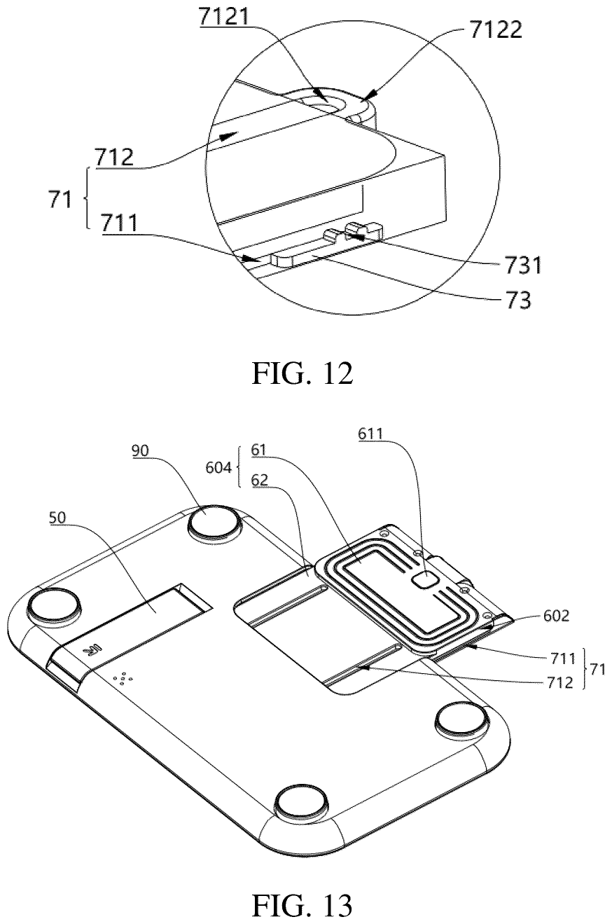

In an embodiment, as shown in FIGS. 11 and 12, the back plate 604 is arranged with a flange 7122 extending towards the limiting post 721. The first guiding slot 712 extends to reach the flange 7122. In this way, a blocking portion 7121 is formed. When the display module 60 extends out from the receiving slot 123 and reaches an extension limited position, the limiting post 721 is located in the first guiding slot 712 in the flange 7122. In this way, the limiting post 721 abuts against a side wall of the flange 7122, limiting a distance of the display module 60 extending out from the body shell, preventing the display module 60 from excessively extending, ensuring stability of the display module 60, and preventing the display module 60 from moving or shaking due to external forces.

In an embodiment, as shown in FIG. 13, the back plate 604 includes a body portion 61 and an extension portion 62. When the display module 60 is retracted inside the body shell 10, the body portion 61 is received in the receiving slot 123, and the extension portion 62 is inserted into the interior of the body shell 10. When the display module 60 extends out from the body shell 10, the body portion 61 extends beyond the edge of the body shell 10, and the display 601 is disposed corresponding to the body portion 61, such that weighing values are exposed and displayed. The first guiding slot 712 is defined in the extension portion 62, such that the display module 60 may be adjusted or moved through the extension portion 62 appropriately when needed. A side of the body portion 61 opposite to the display 601 is always exposed, and a button 611 is provided on the side of the body portion 61 opposite to the display 601 to adjust a weight unit displayed on the display 601.

In an embodiment, as shown in FIG. 13, a thickness of the body portion 61 is greater than a thickness of the extension portion 62, enabling a stepped structure 63 to be formed between the body portion 61 and the extension portion 62. When the display module 60 is retracted into the body shell 10 and reaches a retraction limited position, the stepped structure 63 abuts against the body shell 10. In this way, when the display module 60 is retracted to the retraction limited position, the body portion 61 may be stably supported or positioned. When the stepped structure 63 abuts against the body shell 10, the body portion 61 is aligned with or substantially aligned with the body shell 10, such that the gap between them is reduced, and a compact and aesthetics appearance of the weighing device 1 are improved.

In an embodiment, as shown in FIGS. 11, 13, 14, and 15, the display module 60 further includes a first side surface 602 and a second side surface 603 opposed to each other. Each of the first side surface 602 and the second side surface 603 defines a second guiding slot 711 extending along the sliding direction of the display module 60. A length of the second guiding slot 711 exceeds a length of the extension portion 62, such that two second guiding slots 711 may be positioned respectively on a left side and a right side of both the extension portion 62 and the body portion 61. The guide member structure 72 includes two connecting members 722 arranged on the body shell 10, and each connecting member 722 is inserted into the corresponding second guiding slot 711. The display module 60 may slide along the connecting members 722 via the second guiding slots 711 so as to slide relative to the body shell 10. The arrangement of the second guiding slots 711 and the connecting members 722 enhances the stability of the display module 60 during sliding adjustment.

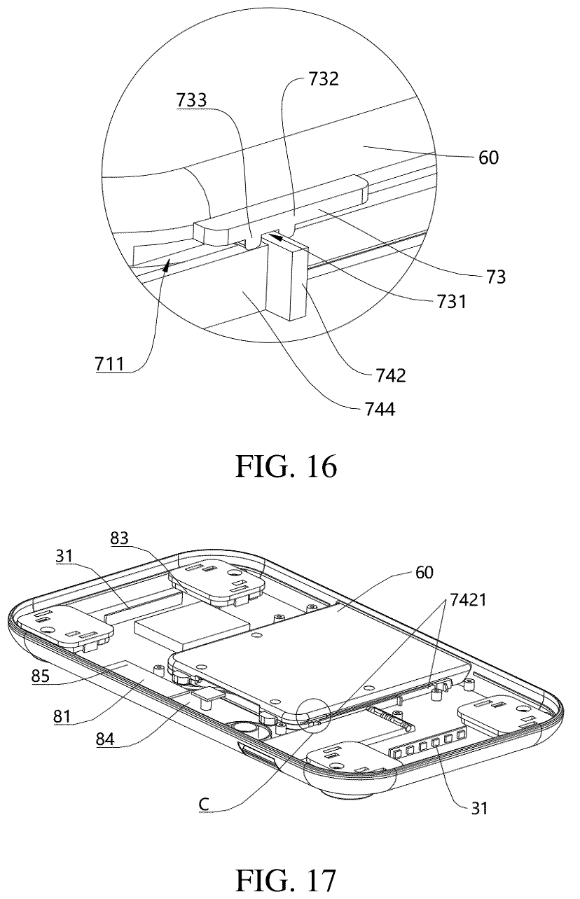

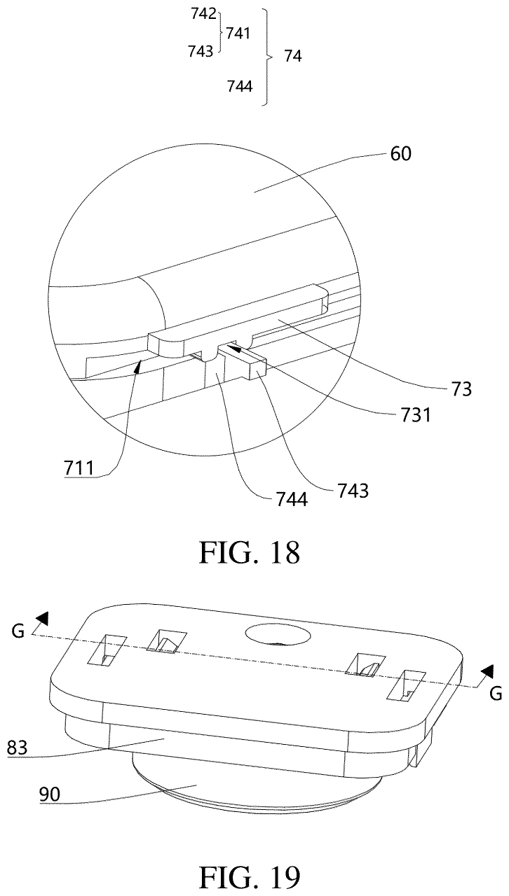

In an embodiment, as shown in FIGS. 16, 17, and 18, the display module 60 is provided with at least one first limiting structure 73, and the body shell 10 is provided with at least one second limiting structure 74. The first limiting structure 73 and the second limiting structure 74 cooperatively limit a movement range of the display module 60. The first limiting structure 73 may be a snap slot 731, and the second limiting structure 74 may be a snap member 741; alternatively, the first limiting structure 73 may be the snap member 741, and the second limiting structure 74 may be the snap slot 731. The snap slot 731 is movably engageable with the snap member 741, i.e., the snap member 741 may be inserted into the snap slot 731 to limit a position of the display module 60. The movable engagement between the snap member 741 and the snap slot 731 allows the user to adjust or move the display module 60 when needed. The arrangement of the first limiting structure 73 and the second limiting structure 74 provides flexibility and ensures stability and safety of the display module 60 while in use.

In an embodiment, as shown in FIGS. 16, 17, and 18, two first limiting structures 73 are arranged, and each of two first limiting structures 73 is the snap slot 731. The two first limiting structures 73 are respectively disposed on the first side surface 602 and the second side surface 603 of the display module 60. Two second limiting structures 74 are arranged and are respectively disposed opposite to the first side surface 602 and the second side surface 603. Each of the first side surface 602 and the second side surface 603 is arranged with a fixing plate 732 extending outward therefrom. Two projections 733 are arranged on the fixing plate 732 and are spaced apart from each other. The snap slot 731 is formed between the two projections 733. The edges of each projection 733 is configured to have rounded corners. The second limiting structure 74 includes a strip-shaped beam 744 extending along the sliding direction of the display module 60. The snap member 741 includes a first snap member 742 and a second snap member 743, which are respectively arranged at two ends 7421 of the strip-shaped beam 744. Each of the first snap member 742 and the second snap member 743 is configured as a block. When the display module 60 slides to two limited positions, the first snap member 742 or the second snap member may be guided by the rounded corners of the projections 733 to be snapped into the snap slot 731 between the two projections 733. At this moment, the user may have a sense of blocking, indicating that the limited position is reached, preventing the display module 60 from falling off due to excessive movement.

In an embodiment, as shown in FIGS. 3, 14, and 17, the weighing device 1 further includes the substrate 11. The mounting space 12 is formed in the body shell 10. The body shell 10 includes the bottom wall 121. The substrate 11 is received in the mounting space 12. A gap 84 is formed between the substrate 11 and the bottom wall 121 of the body shell 10. A master control assembly 81 and a connecting wire 82 are received in the gap 84. The master control assembly 81 is configured to control operation of the display module 60. The connecting wire 82 connects the master control assembly 81 with the display module 60. The master control assembly 81 is electrically connected to the weighing sensor assembly 83, such that the master control assembly 81 may transmit control signals and data to the display module 60 to achieve the weighing and displaying function. The master control assembly 81 and the connecting wire 82 are received in the gap 84, which protects these sensitive components from a pressure applied from the bearing surface 20. This arrangement also helps reduce occupation of an internal space, and results in a more compact overall structure of the weighing device 1.

In an embodiment, as shown in FIGS. 3, 14, and 17, a circuit board 85 is configured as a single-sided circuit board. Electronic components and circuits on the circuit board 85 are arranged on one surface of the circuit board 85. To be noted that, the weighing device 1 of the present disclosure needs to be portable, however, the weighting device 1 has the bearing surface 20, which occupies a certain space. Therefore, any other components arranged inside the weighing device 1 needs to occupy a limited space. Therefore, the circuit board 85 is configured as the single-sided circuit board, having all components and circuits on one surface only, such that a thickness of the weighing device 1 is reduced, and portability of the weighing device 1 is improved.

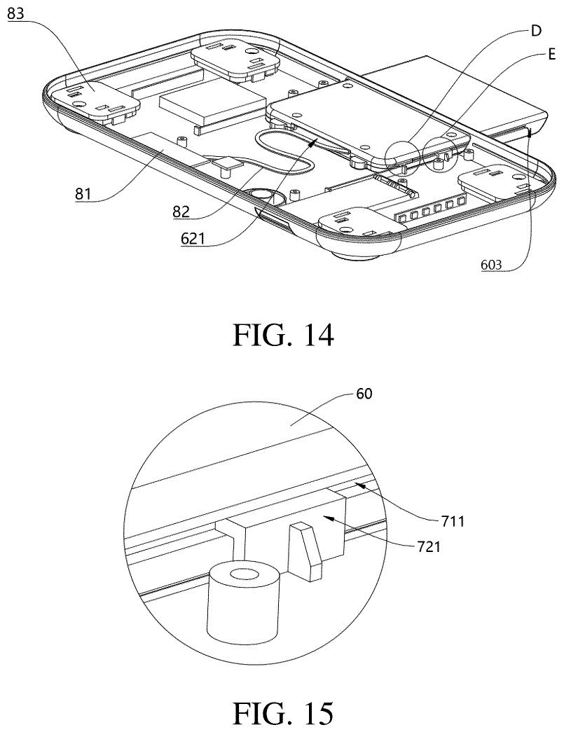

In an embodiment, as shown in FIGS. 8 and 14, a plurality of supports 90 are arranged on the side 122 of the body shell 10 away from the bearing surface 20 to support the body shell 10 on the ground. A plurality of weighing sensor assemblies 83 are provided. Each weighing sensor assembly 83 is arranged in a corresponding support 90, such that the body shell 10 may sense a weight at various locations, providing more accurate weighing results. The plurality of supports 90 are movably connected to the body shell 10, such that a pressure due to weight variation or uneven distribution of the weight may be absorbed, a direct impact on the body shell 10 may be reduced. Each weighing sensor assembly 83 is configured to measure a force applied to the corresponding support 90 to calculate the weight. By arranging the plurality of weighing sensor assemblies 83, more accurate measurements are provided.

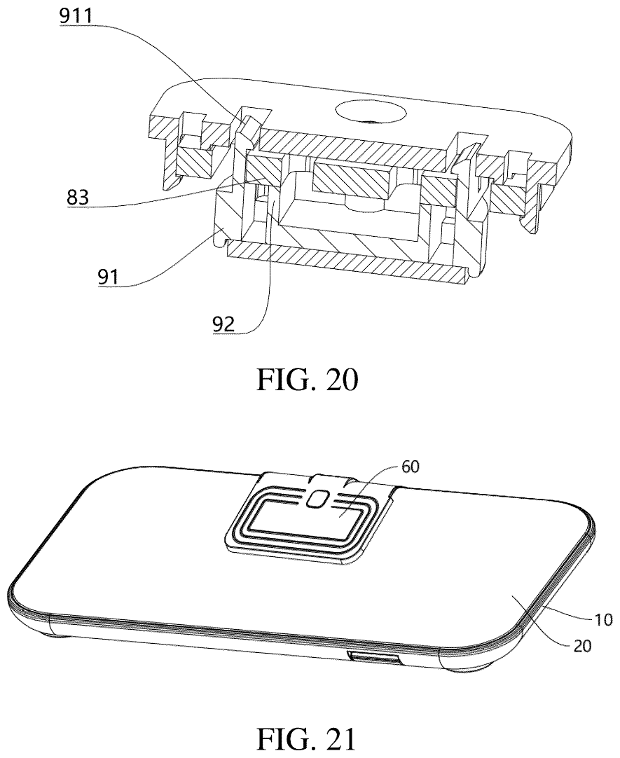

In an embodiment, as shown in FIGS. 19 and 20, each support 90 includes a support body 91, a pressure block 92, and a hook portion 911. The hook portion 911 is arranged on the support body 91, and the hook portion 911 extends through the weighing sensor assembly 83. The hook portion 911 may be snapped downwardly onto the weighing sensor assembly 83 and may be movable upwardly. In this way, when the support body 91 is subjected to a pressure, the hook portion 911 moves upwardly relative to the bearing surface 20, allowing the entire support 90 to move upwardly. The pressure block 92 is arranged inside the support body 91 and is disposed opposite to the weighing sensor assembly 83. Therefore, during weighing the object, when the support body 91 moves upwardly, the pressure block 92 compresses the weighing sensor assembly 83, the weight of the object is transferred through the support 90 to the pressure block 92, the pressure block 92 then transmits the force to the weighing sensor assembly 83. The weighing sensor assembly 83 senses a pressure change and converts the change into an electrical signal. The master control assembly 81 processes the electrical signal, and ultimately a weight reading is displayed. The hook portion 911 is arranged to prevent the weighing sensor assembly 83 from contacting the pressure block 92 when weighing is not performed, reducing friction and wear. It is to be understood that in addition to the movable mounting via the hook portion 911, the support body 91 and the weighing sensor assembly 83 may be elastically connected to each other, such as via an elastic sheet. When the support body 91 is subjected to a pressure, the elastic sheet is elastically compressed, to drive the entire support 90 to move upwardly.

The above description shows only some embodiments of the present disclosure and does limit the present disclosure. Although the present disclosure provides some embodiments, the embodiments are not intended to limit the present disclosure. Any ordinary skilled person in the art may perform changes or modifications without departing the scope of the present disclosure to obtain equivalent embodiments based on the above disclosure. Any simple modifications, equivalent changes and modifications to the above embodiments based on the technical substance of the present disclosure without departing from the content of the present disclosure shall be within the scope of the present disclosure.

What is claimed is:

1. A weighing device, comprising:
a body shell, comprising a bearing surface configured to carry a to-be-weighed object; and
at least one weighing sensor assembly, configured to weigh the to-be-weighed object carried on the bearing surface;
wherein at least a part of the bearing surface serves as a mirror surface.

2. The weighing device according to claim 1, wherein a mounting space is formed in the body shell, and the weighing device further comprises at least one light replenishing assembly received in the mounting space, each of the at least one light replenishing assembly comprises a light source, at least one light-transmitting region is arranged on the bearing surface, and light from the light source is capable of passing through the at least one light-transmitting region to provide supplemental illumination.

3. The weighing device according to claim 2, wherein each of the at least one light replenishing assembly further comprises a light guiding structure and a light shielding portion; the light shielding portion defines a receiving cavity, the light shielding portion comprises a light output side configured as an opening; the light output side is communicated to the receiving cavity; the light source is received in the receiving cavity, and the light source is configured to emit light towards the light output side; the light guiding structure comprises a plane arranged transversely and/or an inclined surface facing the bearing surface; the plane and/or the inclined surface are disposed near the light output side to reflect light from the light source to the at least one light-transmitting region.

4. The weighing device according to claim 2, wherein the light source comprises a light plate and a plurality of light beads arranged on the light plate; the plurality of light beads are capable of switching between cool light and warm light.

5. The weighing device according to claim 1, further comprising a bearing surface protective cover that covers and is detachably connected to the bearing surface.

6. The weighing device according to claim 1, further comprising a bracket, wherein the body shell defines a storage slot, the bracket is movably disposed in the storage slot and configured to be selectively in a first state or a second state;
in the first state, an angle is defined between the body shell and the bracket, and in the second state, the bracket is received in the storage slot.

7. The weighing device according to claim 1, further comprising a display module, wherein the display module comprises a display; the display module is extendably and retractably connected to or foldably arranged with the body shell.

8. The weighing device according to claim 7, wherein the display module is extendably and retractably adjustable in a direction parallel to the bearing surface.

9. The weighing device according to claim 7, wherein a receiving slot is defined in the body shell; the display module is slidably arranged in the receiving slot; one of the display module and the body shell is provided with a guide slot structure, and the other one of the display module and the body shell is provided with a guide member structure; the guide slot structure and the guide member structure are slidably connected to each other.

10. The weighing device according to claim 9, wherein the display module further comprises a back plate; the guide slot structure comprises at least one first guiding slot defined in the back plate; the guide member structure comprises at least one limiting post arranged on the body shell; each of the at least one limiting post is inserted into a respective one of the at least one first guiding slot; each of the at least one first guiding slot is capable of sliding along the respective one of the at least one limiting post.

11. The weighing device according to claim 10, wherein the back plate is arranged with at least one blocking portion; when the display module extends out from the body shell and reaches an extension limited position, the at least one limiting post abuts against the at least one blocking portion.

12. The weighing device according to claim 10, wherein the back plate comprises a body portion and an extension portion; when the display module is retracted inside the body shell, the body portion is received in the receiving slot, the extension portion is inserted into an interior of the body shell, and the at least one first guiding slot is defined in the extension portion.

13. The weighing device according to claim 12, wherein a thickness of the body portion is greater than a thickness of the extension portion to form a stepped structure between the body portion and the extension portion; when the display module is retracted into the body shell and reaches a retraction limited position, the stepped structure abuts against the body shell, and the body portion is aligned with or substantially aligned with the body shell.

14. The weighing device according to claim 9, wherein the display module further comprises a first side surface and a second side surface opposed to each other; the guide slot structure comprises two second guiding slots defined in the first side surface and the second side surface, respectively; the guide member structure comprises two connecting members, and the two connecting members are arranged on the body shell and are inserted into the two second guiding slots, respectively; the display module is slidable relative to the body shell through the two second guiding slots and the two connecting members.

15. The weighing device according to claim 14, wherein the display module is arranged with at least one first limiting structure, and the body shell is arranged with at least one second limiting structure; one of the first limiting structure and the second limiting structure defines a snap slot, and the other of the first limiting structure and the second limiting structure is arranged with a snap member; the snap member is movably engageable with the snap slot.

16. The weighing device according to claim 15, wherein the second limiting structure further comprises a strip-shaped beam; the strip-shaped beam extends in a sliding direction of the display module; the snap member comprises a first snap member and a second snap member; the first snap member and the second snap member are arranged at two ends of the strip-shaped beam, respectively; the snap slot is defined in the display module; when the display module is retracted into the body shell and reaches a retraction limited position, the snap slot is movably engageable with the first snap member; when the display module is extended out from the body shell and reaches an extension limited position, the snap slot is movably engageable with the second snap member.

17. The weighing device according to claim 7, further comprising a substrate, a master control assembly, and a connecting wire; wherein the body shell defines a mounting space, the substrate is received in the mounting space, the body shell comprises a bottom wall, a gap is formed between the substrate and the bottom wall, the master control assembly and the connecting wire are received in the gap, and the connecting wire connects the master control assembly with the display module.

18. The weighing device according to claim 17, wherein the master control assembly comprises a circuit board, the circuit board is configured as a single-sided circuit board.

19. The weighing device according to claim 1, further comprising a plurality of supports, wherein the plurality of supports are arranged on a side of the body shell away from the bearing surface, and the plurality of supports are movably connected to the body shell; the number of the at least one weighing sensor assembly is more than one, each of the more than one weighing sensor assemblies is arranged on a respective one of the plurality of supports.

20. The weighing device according to claim 19, wherein each of the plurality of supports comprises a support body, a pressure block, and at least one hook portion arranged on the support body; the hook portion extends through the respective one of the more than one weighing sensor assemblies; the hook portion is snapped downwardly to the respective one of the more than one weighing sensor assemblies and is capable of moving upwardly; the pressure block is disposed in the support body and opposite to the respective one of the more than one weighing sensor assemblies; when weighing is performed, the support body moves upwardly relative to the bearing surface, and the pressure block compresses the respective one of the more than one weighing sensor assemblies.
